(19) United States
(12) Patent Application Publication
(10) Pub. No.: US 2025/0208053 A1
(43) Pub. Date: Jun. 26, 2025

(54) IMAGING SYSTEMS AND RELATED METHODS

(71) Applicant: Gemological Institute of America, Inc., Carlsbad, CA (US)

(72) Inventors: Zhen WANG, Secaucus, NJ (US); Tsung-Han TSAI, Maywood, NJ (US)

(21) Appl. No.: 18/988,504

(22) Filed: Dec. 19, 2024

Related U.S. Application Data
(60) Provisional application No. 63/612,839, filed on Dec. 20, 2023.

(51) Int. Cl. G01N 21/87; G02B 21/00; G06V 10/145; G06V 20/69

(52) U.S. Cl. CPC G01N 21/87; G06V 10/145; G06V 20/693; G01N 2201/062; G01N 2201/0636; G02B 21/0028; G02B 21/0032; G02B 21/0052; G02B 21/008

(57) ABSTRACT

Imaging systems and related methods are disclosed herein. An imaging system includes a stage, a top electromagnetic (EM) radiation source, a bottom EM radiation source, an objective lens, an image capture device, and a reflective surface. The stage supports a material sample. The stage includes an aperture. The top EM radiation source directs diffuse EM radiation downwardly toward the material sample supported by the stage. The bottom EM radiation source directs EM radiation toward the material sample through the aperture. The objective lens is positioned above the stage and collects EM radiation from the material sample and forms a magnified image of at least a portion of the material sample. The image capture device generates digital image data of the magnified image. The reflective surface is positioned to receive EM radiation via the objective lens and to reflect the EM radiation laterally to form the magnified image.

### CROSS-REFERENCE TO RELATED APPLICATIONS

This application claims the benefit of U.S. Provisional Application No. 63/612,839, filed Dec. 20, 2023, the entire disclosure of which is hereby incorporated herein by this reference.

### FIELD

The field relates generally imaging systems and related methods for viewing material imperfections in sample materials. The field may relate more particularly, in some embodiments, to improving viewing of and image capture of internal and surface inscriptions in gemstones.

### BACKGROUND

Laser inscription is widely used for gemstone society. Laser inscription may be used to mark control number, logo, quick response (QR) code, bar code, or any other targeting feature inside or on the surface of gemstone samples. The inscription itself can be unique for every single stone and can be used as unique marking for screening and identification. Two types of laser inscription include surface and internal inscription. Viewing devices for surface inscription are already commercially available, but viewing devices for internal inscription are not available.

Conventionally, inscription viewing was difficult and based on visual evaluation using a microscope and a desk lamp to localize and identify internal inscriptions. This was difficult, especially for white inscriptions, also known as “invisible inscriptions,” which required the use of a petrology microscope with specially designed lightning and high magnitude objectives in order to read these inscriptions. Equipment used for detecting these inscriptions was expensive, heavy, and complicated, and was not portable.

A common type of internal inscription is black inscription with line width between 1 μm and 10 μm. This type of inscription may be read using a laboratory microscope. Another type of internal inscription is the above-mentioned white inscription (invisible inscription), which may be considered invisible when viewed using a standard gemological microscope and was conventionally only seen either by using a regular microscope with objective lens magnification higher than or equivalent to 50×, or with a petrology microscope coupled with special lightning conditions. However, both of these conventional ways of viewing white inscriptions are expensive and are not portable. As surface inscription is already widely applied in diamond markets and internal inscription application has a significant growing demand, development of an easy-to-use viewing device with lower cost would be helpful.

### SUMMARY

In some embodiments, an imaging system includes a stage, a top electromagnetic (EM) radiation source, a bottom EM radiation source, an objective lens, an image capture device, and a reflective surface. The stage supports a material sample, The stage includes an aperture. The top electromagnetic (EM) radiation source directs diffuse EM radiation downwardly toward the material sample supported by the stage. The bottom EM radiation source directs EM radiation toward the material sample through the aperture. The objective lens is positioned above the stage, collects EM radiation from the material sample, and forms a magnified image of at least a portion of the material sample. The image capture device generates digital image data of the magnified image. The reflective surface is positioned to receive EM radiation via the objective lens and to reflect the EM radiation laterally to form the magnified image.

In some embodiments, an imaging system includes a stage, a top electromagnetic (EM) radiation source, a bottom EM radiation source, an objective lens, a reflective surface, and an image capture device. The stage is configured to support a material sample. The stage comprises an aperture. The top EM radiation source is configured to provide top EM radiation to the material sample supported by the stage. The bottom EM radiation source is configured to provide bottom EM radiation to the material sample through the aperture of the stage. The objective lens is configured to provide magnified EM radiation responsive to EM radiation from the material sample. The reflective surface is configured to provide reflected EM radiation responsive to the magnified EM radiation. The image capture device is configured to generate digital image data corresponding to a digital image responsive to the reflected EM radiation.

In some embodiments, a method of detecting an inscription in a gemstone includes supporting the gemstone on a stage including an aperture, providing, by a top electromagnetic EM radiation source, diffuse EM radiation to the gemstone, providing, by a bottom EM radiation source, bottom EM radiation to the gemstone through the aperture of the stage, and providing, by an objective lens, magnified EM radiation responsive to EM radiation from the gemstone. The method also includes, providing, by a reflective surface, reflected EM radiation responsive to the magnified EM radiation, generating, by a camera, digital image data corresponding to a digital image responsive to the reflected EM radiation, and adjusting, by a computing system, the stage to place the inscription of the gemstone into a field of view of the camera. The method further includes zooming into the image at the inscription and processing the zoomed image to recognize the inscription.

In some embodiments, a system for imaging inscriptions in a gemstone includes a digital camera configured to capture digital images, a mirror configured to reflect light to the digital camera, an objective lens configured to magnify light passing through it to the mirror and digital camera, a stage configured to support a gemstone culet in an aperture of the stage, a top diffuse LED configured to illuminate the stage and gemstone supported on it, and a bottom LED configured to illuminate through the aperture. In some examples, additionally or alternatively, the stage with the aperture is an adjustable iris shutter stage. In some examples, additionally or alternatively, the top diffuse LED is an annular shaped LED. In some examples, additionally or alternatively, the objective lens is in the middle of and encircled by the annular top diffuse LED. In some examples, additionally or alternatively, the top diffuse LED is a white light LED and the bottom LED is a red light LED. The top diffuse LED and the bottom LED may be any color or wavelengths, so long as the colors and wavelengths are within the camera's sensing range. For example, the top diffuse LED and the bottom LED may emit EM radiation in the visible or near infrared (NIR) spectrum (400 to 900 nm wavelength). In some instances, a color camera may be sensitive to detect EM radiation within a wavelength range of 400 to 700 nm. In some instances, the wavelength range of detection of the camera may be different (e.g., broader, narrower, covering a different range, etc.). In some instances, the camera may include a monochromatic camera sensitive to visible and NIR wavelengths of up to 900 nms. In some examples, additionally or alternatively, the digital camera includes an imaging lens. In some examples, additionally or alternatively, the stage includes stage motors configured to allow movement of the stage in an x, y, and/or z direction. In some examples, additionally or alternatively, the stage includes tilt stage motors configured to allow tilting of the stage about an x and/or y axis. In some examples, additionally or alternatively, further comprising a directional top-side LED adjacent the top diffuse LED, the directional top-side LED configured to illuminate a table of the gemstone on the stage from a side angle.

Systems and methods here may be used for finding and imaging inscriptions in a gemstone. A method includes supporting the gemstone table side up with a gemstone culet in an aperture of a stage, causing a top of stage diffused LED to illuminate the gemstone on the stage, and capturing an image of the gemstone by a digital camera using the top of stage diffused LED to identify black surface inscriptions of the gemstone. The method also includes adjusting x, y, or z stage motors in communication with the stage to place any inscription of the gemstone in a field of view of the digital camera, digitally zooming, using software, of the image captured of the gemstone to check any inscriptions of the gemstone, and applying optical character recognition to any internal inscription of the image captured from the gemstone.

In some embodiments, the method includes causing a top-side LED to directionally illuminate the gemstone on the stage in addition to the top of stage LED and capturing an image of the gemstone by the digital camera to identify shallow surface inscriptions of the gemstone with very shallow depth. In some examples, additionally or alternatively, the method further comprises causing a bottom LED to illuminate the gemstone on the stage through the aperture point illumination in addition to the top of stage LED and capturing an image of the gemstone by the digital camera to identify internal inscriptions of the gemstone. In some examples, additionally or alternatively, capturing the image for surface inscription is less than 100 nm deep. In some examples, additionally or alternatively, the stage is an adjustable iris and the method further comprises adjusting the aperture by the adjustable iris shutter to match a size of the culet of the gemstone. In some examples, additionally or alternatively, the top diffused LED is ring-shaped with an objective lens in the middle. The objective lens is configured to focus light from the stage to the digital camera. In some examples, additionally or alternatively, the objective lens is configured for 5× magnification. In some examples, additionally or alternatively, the objective lens is configured for 10× magnification. In some examples, additionally or alternatively, the adjustable iris shutter is configured to adjust between 0.5 mm and 2 mm in diameter. In some examples, additionally or alternatively, the camera includes an imaging lens. In some examples, additionally or alternatively, capturing an image of the gemstone by a digital camera includes capturing a mirror reflection of the gemstone.

### BRIEF DESCRIPTION OF THE DRAWINGS

For a better understanding of the embodiments described in this application, reference should be made to the Detailed Description below, in conjunction with the following drawings in which like reference numerals refer to corresponding parts throughout the figures.

FIG. 1A and FIG. 1B are illustration of an example imaging system, according to some embodiments;

FIG. 2 shows an imaging system, which is an example of the imaging system discussed with reference to FIG. 1A and FIG. 1B;

FIG. 3A and FIG. 3B are a top view and a side view, respectively, of a stage, which is an example of the stage of FIG. 1A and FIG. 1B;

FIG. 4 illustrates an aspect of the subject matter in accordance with one embodiment.

FIG. 5A and FIG. 5B are perspective views of a manually-adjustable stage, which is an example of the stage of FIG. 1A and FIG. 1B;

FIG. 6A and FIG. 6B illustrate examples of a side-to-side scan pattern and a spiral scan pattern, respectively, across a table of a gemstone of FIG. 1A that may be used to search for an inscription in the gemstone;

FIG. 7 is a flowchart illustrating a method of finding and capturing images of inscriptions in a sample material, according to some embodiments;

FIG. 8 is a flowchart illustrating a method of detecting an inscription in a gemstone;

FIG. 9 is a diagram of an example networked system in accordance with certain aspects described herein; and

FIG. 10 is a diagram of an example computing system in accordance with certain aspects described herein.

### DETAILED DESCRIPTION

Reference will now be made in detail to embodiments, examples of which are illustrated in the accompanying drawings. In the following detailed description, numerous specific details are set forth in order to provide a sufficient understanding of the subject matter presented herein. But it will be apparent to one of ordinary skill in the art that the subject matter may be practiced without these specific details. Moreover, the particular embodiments described herein are provided by way of example and should not be used to limit the scope of the particular embodiments. In other instances, well-known data structures, timing protocols, software operations, procedures, and components have not been described in detail so as not to unnecessarily obscure aspects of the embodiments herein.

As used herein, the term “light” refers to electromagnetic radiation within and outside of a visible spectrum. Although imaging using electromagnetic (EM) radiation within the visible spectrum may be useful to identify structures or inscriptions in or on a sample material, other spectra outside of the visible light spectrum may also be useful to identify structures or inscriptions in or on a sample material. For example, infrared, ultraviolet, and other EM spectra may be useful in drawing optical contrast in some situations where the visible spectrum may be less useful in drawing optical contrast.

In some embodiments, inscriptions on or in a material sample (e.g., a gemstone) may include surface inscriptions, shallow internal inscriptions, or internal inscriptions. For example, surface inscriptions may include inscriptions extending from a surface of a material sample into the material sample up to one hundred microns (100 μm) deep. For example, a surface inscription may extend at least substantially 10 μm into the material sample from the material sample's surface. As another example, shallow internal inscriptions may extend from 10 to 200 μm deep from a surface of the material sample but may not extend to the surface. As a further example, internal inscriptions and deep internal inscriptions may extend into the material sample deeper than 200 μm from the surface of the material sample.

Systems and methods described here may be used to view and capture images of internal gemstone inscriptions and surface inscriptions using a small, portable system. This system may image otherwise difficult-to-image inscriptions and uses less magnification than conventional systems. As is popular today, gemstone internal and surface inscriptions may be made in various ways and include different designs such as a control number, logo, quick response (QR) code, or any other targeting feature. The system provides a proper lighting and imaging environment to see both surface and internal inscriptions, which may include black or invisible (white) inscriptions.

After capture, images may be processed by the computer to analyze and/or store captured inscription features, read and analyze the control number, and match or analyze a logo and any other targeting feature. In some examples, the system may be used to scan a QR code, a bar code, or any hyperlink-related feature to correlate with a back-end database for diamond or gemstone analysis or identification. The device may be used for different types of gemstone samples including diamonds, colored stones, pearls, or any other type of gemstone samples.

Compared to conventional imaging systems, imaging systems according to embodiments disclosed herein significantly simplify setup and shorten the time used to check both surface and internal inscription of gemstone samples. Imaging systems according to embodiments disclosed herein may utilize less magnification than conventional systems to capture images of inscriptions that would otherwise involve higher magnification to capture.

Viewing devices according to embodiments disclosed herein may be used to check both surface and internal inscriptions. For internal inscription, viewing devices according to embodiments disclosed herein may also be used to see both white (invisible) markings and also black inscriptions. Such a system may enable digital image capture and digital zoom, which allows for imaging for inscriptions that are relatively small or otherwise difficult to find and view. For example, white inscriptions (invisible or near invisible inscriptions) may have different sizes with different material modification depths. Depths may vary in level from microns to millimeters deep for both visible (black) and invisible (white) inscriptions.

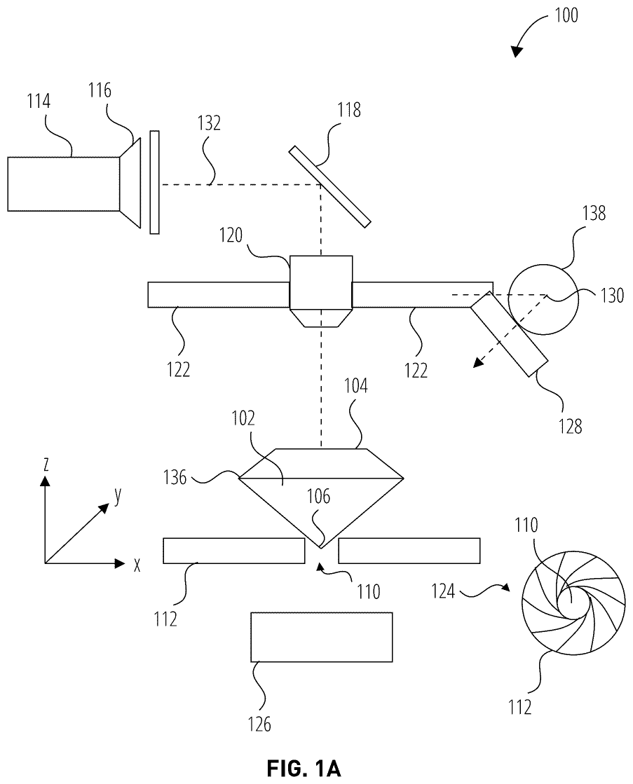

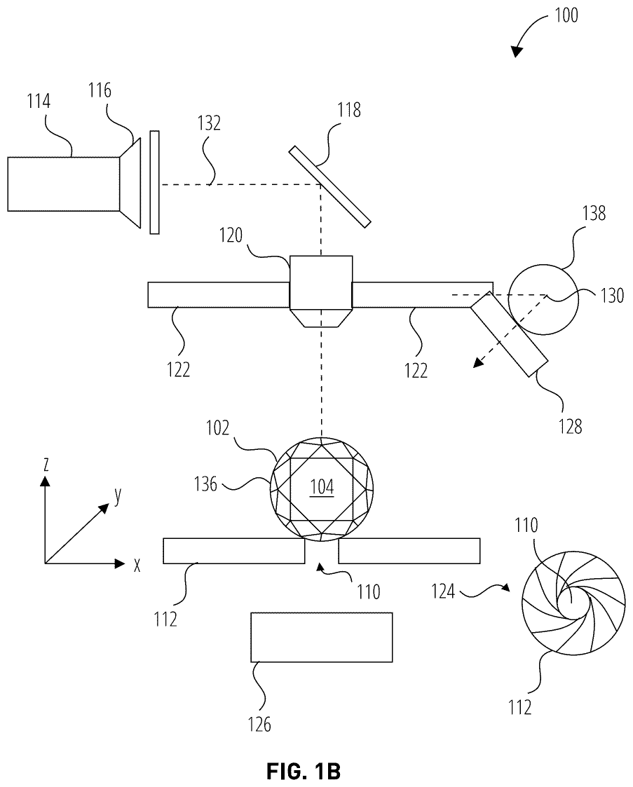

Systems disclosed here may include a collection of component parts assembled inside a portable base that allows for a human user to pick it up, move it, and place it on a tabletop for easy use. Systems disclosed herein may be used, for example, in a retail environment such as a storefront. An example of such hardware is shown in FIG. 1A to FIG. 1B.

FIG. 1A and FIG. 1B are illustrations of an example imaging system 100, according to some embodiments. The imaging system 100 includes a camera 114 for digital image capture and viewing, a stage 112 to support a gemstone 102, optical components including a mirror 118 and an objective lens 120, and lighting components including one or more of a top light arrangement 122, a top-side light 128, or a bottom light source 126.

The camera 114 may include any of various high resolution digital image capturing systems that are configured to capture an image and store the image data as digital pixelated image data in computer storage for analysis such as matching, optical character recognition (OCR) analysis, or other image analysis. The camera 114 may be configured to cause generation of a digital image that a user may zoom or enlarge on a digital display. The higher the resolution of the camera 114, the more zoom capability the user and system would be able to use for any captured images.

In the example of FIG. 1A and FIG. 1B, the camera 114 may include an imaging lens 116. The lens 116 may be used to aim the camera 114 at a target or objective such as a table 104 of the gemstone 102. In some examples, a mirror 118 (e.g., a silver mirror) or other reflective surface may be used to reflect light from the stage 112 and gemstone 102 to the camera 114.

An arrangement of the camera 114 and imaging lens 116 using the mirror 118 may result in a more compact system package than conventional imaging systems, allowing for a ninety degree angle of a field of view 132 (e.g., line of sight) of the imaging camera 114 to the gemstone 102 and stage 112. Other angles besides ninety degrees may also be used to offset the camera field of view and the stage using one or more mirrors. The example of ninety degrees is not intended to be limiting.

In the example of FIG. 1A and FIG. 1B, the camera 114 may be arranged to the side (e.g., offset in an x or y direction based on the x-y-z coordinate system illustrated in FIG. 1A and FIG. 1B) of the other components (e.g., the top light arrangement 122, the mirror 118, the objective lens 120, etc.) to make the overall packaging of the system smaller or more compact compared to that of conventional imaging systems. The camera 114 may instead be directly pointed at the stage 112 without using the mirror 118, but this arrangement would involve an overhead camera arrangement, which may result in the overall system being taller than may otherwise be arranged using a mirrored arrangement as shown in FIG. 1A and FIG. 1B or similar.

The example of FIG. 1A and FIG. 1B shows the camera 114 pointed at the mirror 118, which is configured to reflect light from the stage 112 and gemstone 102 to the camera imaging lens 116 and the camera 114. A mirror 118 arrangement is optional or could include multiple mirrors.

A lighting arrangement above (in a z direction of the x-y-z axis shown in FIG. 1A) the stage 112 includes an achromatic objective lens 120 surrounded by a diffused top light arrangement 122. In some examples, this achromatic objective lens 120 has a lower magnification than would otherwise be used to view inscriptions without the systems and methods described herein. For example, this achromatic objective lens 120 may only use a magnification of 5X or 10X, which may be cheaper than and/or weigh less than higher magnification lenses. Unlike other systems using 50× or 100× magnification to view and analyze internal inscriptions, the imaging system 100 uses a cheaper, less heavy, more portable, and lower magnification lens.

The objective lens 120 may focus light from the gemstone 102 and stage 112 and direct the light to the camera 114. In some embodiments, the lighting equipment is reflected off one or more mirrors 118.

In some examples, this top light arrangement 122 may include an LED light arrangement. In some examples, this top light arrangement 122 may be a diffuse light arrangement. In some examples, the top light arrangement 122 includes a white light LED. In some examples, the top light arrangement 122 includes a circular or annular arrangement (e.g., a single annular LED or an annular arrangement of LEDs) surrounding the achromatic objective lens 120. Any or all combinations or permutations of this top light arrangement 122 may be arranged without limitation.

In embodiments where the top light arrangement 122 includes circular and/or annular lighting equipment arrangement, the top light arrangement 122 may provide diffuse light from a position that surrounds or encircles the achromatic objective lens 120. The top light arrangement 122 is configured to provide diffused light (e.g., diffused LED lighting equipment) to illuminate the stage 112 below the top light arrangement 122 and below the surrounded achromatic objective lens 120. The top light arrangement 122 may include a diffuse uniform top light arrangement 122 that provides diffused uniform light for black surface and black internal inscription viewing and image capture. In some examples, this light may be selectable to be turned on, or off and on, at different intensities. In some examples, a computer system to be connected to or to be in communication with the digital camera, may control turning on and off and/or the intensity of the top light arrangement 122. In some examples, the top light arrangement 122 may provide white light.

FIG. 1A shows a gemstone 102 (e.g., a diamond) placed table 104 side up on a stage 112 for analysis. The table 104 of the gemstone 102 is facing up and the culet 106 is at a bottom. In such an arrangement, the gemstone 102 may be illuminated and images captured of the table 104 and internal portions of the gemstone 102 in order to analyze and store images.

In some example embodiments, the stage 112 includes an opening or aperture 110. In some examples, this opening may be adjustable in the stage 112 itself. In some examples, an adjustable shutter controls the size of the aperture 110. For example, the stage 112 may include an iris-type shutter 124 configured to adjust to open and close to form differently-sized apertures 110. In such examples, the opening or aperture 110 may be arranged to hold or support a gemstone 102 culet 106 with the table 104 of the gemstone 102 facing up. The culet 106 of the gemstone 102, for a round brilliant type cut or other cut with a culet, may be placed in and supported by the sides of the iris-type shutter 124 forming the aperture 110. In some examples, this aperture 110 allows light from the bottom light source 126 below the stage 112 to illuminate the gemstone from below through the culet 106. The bottom light source 126 is arranged below the stage 112 such that light is travels through the aperture 110. Accordingly, the gemstone 102 may be illuminated from below by the bottom light source 126, through the aperture 110, to and through its culet 106, as if from a point source of light or illumination. By way of non-limiting example, the top light arrangement includes one or more LEDs capable of emitting light across a first spectrum (e.g., white light) and the bottom light source includes one or more LEDs capable of emitting light across a second spectrum (e.g., red light) that is different from the first spectrum.

In some examples, the aperture 110 is an adjustable aperture such as an iris-type shutter 124 aperture configured to opening and close to form differently-sized apertures that may accommodate differently-sized culets of gemstones. In some examples, the aperture 110 is configured to be adjustable between diameters of 0.2 mm and 2 mm by the sides of the iris-type shutter 124 assembly. In some examples, the aperture 110 is configured to be adjustable between diameters of 0.2 mm and 3 mm. In some examples, the adjustable iris-type shutter 124 is able to be adjusted manually by a human user operator who loads a gemstone or diamond table side up, with the culet 106 in the aperture 110 to hold the gemstone upright for analysis. In some examples, an automated computer system may be used to adjust the iris-type shutter 124 aperture 110 diameter for differently-sized gemstones or diamond culets 106 to hold the gemstones in place and allow for lighting beneath the gemstone.

This arrangement for lighting the gemstone 102 through the aperture 110 of the stage 112 through the culet 106 allows for a top-down camera to view black inscriptions within the table or internal volume of the gemstone.

Additionally, white, or equivalently invisible, inscriptions may otherwise be difficult to see because the gemstone modification to achieve such inscriptions may be relatively minor. In order to see white inscriptions with the imaging system 100 having such a small, modified volume, the point light source from the aperture 110 may be used. Absent this illumination from below through the aperture 110, only diffused omnidirectional light may be used, and small modifications are not easily visible. By illuminating the gemstone 102 from below, through the pinpoint culet aperture 110, any inscriptions in the table 104 of or otherwise internal to the gemstone 102 may be backlit to view the inscriptions from the top.

FIG. 1B shows the imaging system 100 of FIG. 1A with the gemstone 102 turned on its side such that a girdle 136 of the gemstone 102 would be facing up toward the achromatic objective lens 120 and camera field of view 132.

Such an arrangement may allow for the camera 114 to better detect and capture any internal inscriptions in the gemstone 102 (e.g., diamond) than would otherwise be possible by other lighting arrangements.

In some examples, a shallow surface inscription may be made on a gemstone. Such shallow inscription may be difficult to see with only direct light or only diffuse light. In such examples, it may be useful to utilize a top-side light 128 such as an LED light that illuminates the gemstone in order to allow viewing and image capture of shallow inscriptions.

In some example embodiments, the top-side light 128 may be used in addition to the top light arrangement 122. In such examples, the top-side light 128 may be a directional light illuminating the stage 112 and any gemstone (e.g., gemstone 102) on the stage 112 from an angle 130 instead of diffuse light or light shining directly straight down on the stage 112. In some examples, the angle 130 of the top-side light 128 may be anywhere from 90 degrees to 150 degrees from horizontal (horizontal being parallel to the x direction of the x-y-z axis).

In some examples, the top-side light 128 may be configured with an angle motor 138 to move the angle 130 of the top-side light 128 to illuminate the table 104 of the gemstone 102 at slightly different angles of angle 130 to allow searching for shallow inscriptions. The top-side light 128 may be used to illuminate a table 104 of the gemstone 102 placed on the stage 112. By configuring the top-side light 128 at a shallow angle 130, the light may reflect off the table 104 and any shallow surface inscriptions for the camera 114 to enable detection and/or image capture. By illuminating the table 104 at this angle 130, the light may reflect and refract off of any shallow inscriptions that would otherwise be invisible or hard to see if only viewed with the top light arrangement 122 at a single angle. In some examples, such an optional top-side light 128 to view the shallow inscriptions may be selectively turned on/off and intensity may be adjusted. In some examples, the top light arrangement 122 may be selectively turned on and off and intensity adjusted. In some examples, such control may be manual by a human user. In some examples, a computer may be used to control the light on/off and in some examples, intensity.

In some examples, a distance between the top light arrangement 122 and the stage 112 is 4 cm.

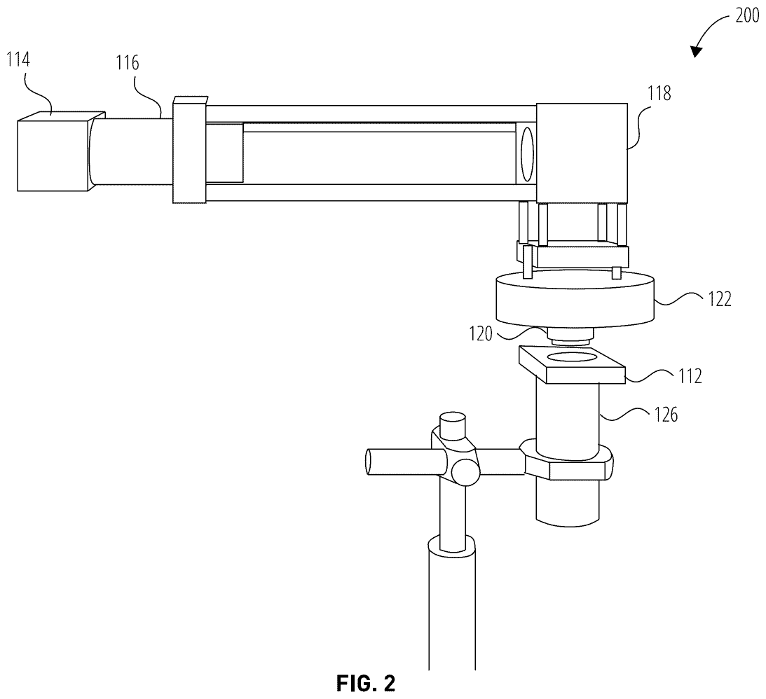

FIG. 2 shows an imaging system 200, which is an example of the imaging system 100 discussed with reference to FIG. 1A and FIG. 1B. The imaging system 200 illustrated in FIG. 2 includes examples of the camera 114, the lens 116, the mirror 118, the objective lens 120, the top light arrangement 122, the stage 112, and the bottom light source 126 discussed with reference to FIG. 1A and FIG. 1B.

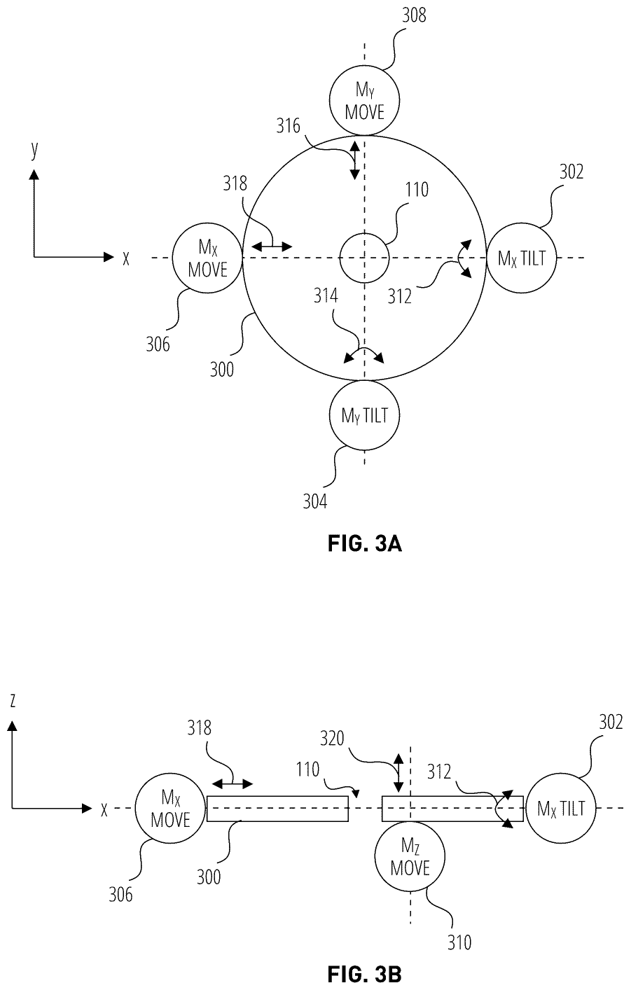

FIG. 3A and FIG. 3B are a top view and a side view, respectively, of a stage 300, which is an example of the stage 112 of FIG. 1A and FIG. 1B. In some embodiments, the stage 300 includes stage motors that may be used to tilt the stage 300 in order to change the angle of the stage 300 and thereby change an angle of the table 104 of the gemstone 102 (FIG. 1) from horizontal to off-horizontal, or back and forth from horizontal to off-horizontal. For example, the stage 300 may include an x-axis tilt motor 302 configured to rotate 312 the stage 300 around an axis oriented in the x-direction. As another example, the stage 300 may include a y-axis tilt motor 304 configured to rotate 314 the stage 300 around an axis oriented in the y-direction.

In some examples, a gemstone or diamond (e.g., the gemstone 102 of FIG. 1A and FIG. 1B) may sit culet 106 side down in the adjustable aperture 110 as in FIG. 1A, or on its side as in FIG. 1B. An arrangement of motors may be used to move or adjust the stage 300. Such an arrangement may use step motors or other electric motors to move the stage 300 in one x, two x-y, or three x-y-z dimensions. For example, the stage 300 may include an x-axis movement motor 306 configured to move 316 the stage 300 along a direction of the x-axis. As another example, the stage 300 may include a y-axis movement motor 308 configured to move 318 the stage 300 along a direction of the y-axis. As a further example, the stage 300 may include a z-axis movement motor 310 configured to move 320 the stage 300 in a direction of the z-axis. Such stage movement may be useful to search for and bring any inscriptions in the gemstone within the field of view 132 of the camera 114 (FIG. 1A and FIG. 1B).

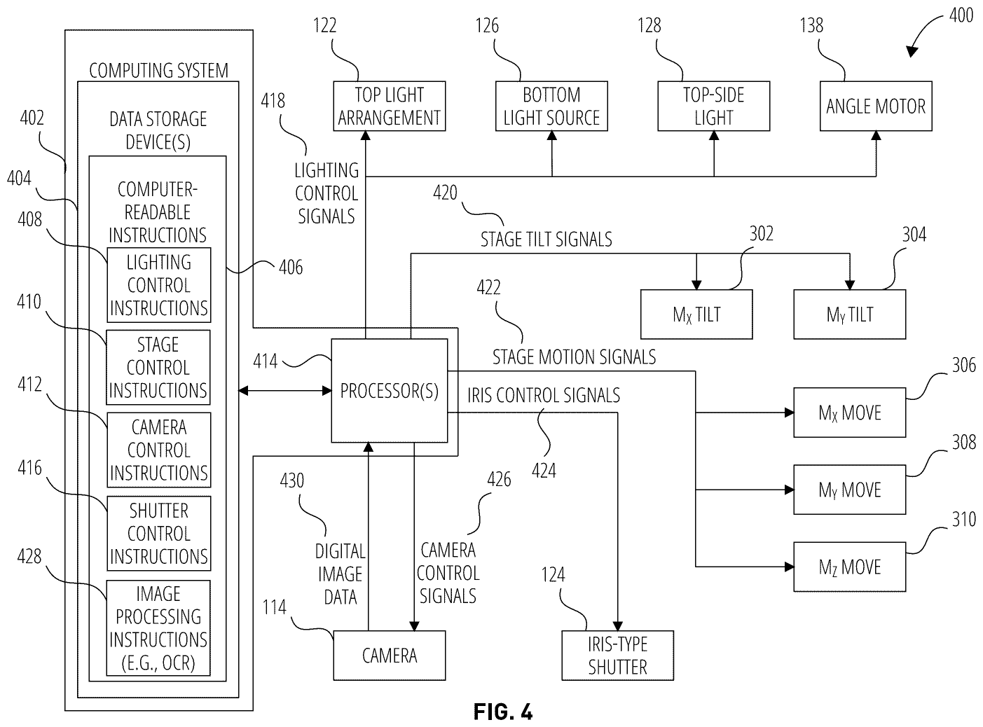

FIG. 4 is a block diagram of an imaging system 400, which is an example of the imaging system 100 of FIG. 1A and FIG. 1B. The imaging system 400 includes a computing system 402 configured to control operation of various other components of the imaging system 400. For example, the computing system 402 may be configured to control one or more of the top light arrangement 122, the bottom light source 126, the top-side light 128, the angle motor 138, and/or the camera 114 of FIG. 1A and FIG. 1B; and/or the x-axis tilt motor 302, the y-axis tilt motor 304, the x-axis movement motor 306, the y-axis movement motor 308, and/or the z-axis movement motor 310 of FIG. 3A and FIG. 3B.

The computing system 402 includes one or more processors 414 and one or more data storage devices 404 operably coupled to the processors 414. The data storage devices 404 includes computer-readable instructions 406 stored thereon. The computer-readable instructions 406 include lighting control instructions 408, stage control instructions 410, camera control instructions 412, shutter control instructions 416, and image processing instructions 428. The computer-readable instructions 406 are configured to instruct the on or more processors 414 to control lighting of the imaging system 400. For example, the lighting control instructions 408 may be configured to instruct the one or more processors 414 to provide lighting control signals 418 to the top light arrangement 122, the bottom light source 126, the top-side light 128, and/or the angle motor 138. In some embodiments, the lighting control signals 418 may be configured to control turning on and off of the top light arrangement 122, the bottom light source 126, and the top-side light 128. In some embodiments, the lighting control signals 418 may also be configured to control an intensity of EM radiation provided by the top light arrangement 122, the bottom light source 126, and the top-side light 128. In some embodiments, the lighting control signals 418 may also be configured to control the angle motor 138 to control the angle 130 (FIG. 1A and FIG. 1B) of the top-side light 128.

The computer-readable instructions 406 are also configured to instruct the processors 414 to control tilt and movement of the stage 300 of FIG. 3A and FIG. 3B. For example, the stage control instructions 410 are configured to instruct the processors 414 to provide stage tilt signals 420 to the x-axis tilt motor 302 and the y-axis tilt motor 304 to control a tilt of the stage 300 about axes parallel to the x-direction and the y-direction (FIG. 3A and FIG. 3B), respectively. Also, the stage control instructions 410 are configured to instruct the processors 414 to provide stage motion signals 422 to the x-axis movement motor 306, the y-axis movement motor 308, and the z-axis movement motor 310 to control movement of the stage 300 in the x-direction, the y-direction, and the z-direction, respectively.

The computer-readable instructions 406 are further configured to instruct the processors 414 to control the iris-type shutter 124 to adjust the size of the aperture 110 (FIG. 1A and FIG. 1B). For example, the shutter control instructions 416 may be configured to instruct the processors 414 to provide iris control signals 424 to the iris-type shutter 124 to control the size of the aperture 110.

The computer-readable instructions 406 are also configured to instruct the processors 414 to control the camera 114. For example, the camera control instructions 412 may be configured to instruct the processors 414 to provide camera control signals 426 to the camera 114 to trigger the camera 114 to capture digital image data 430 corresponding to a digital image responsive to EM radiation (e.g., reflected EM radiation from the mirror 118 of FIG. 1A and FIG. 1B).

The computer-readable instructions 406 are also configured to instruct the processors 414 to process digital image data 430 received from the camera 114. For example, the image processing instructions 428 may be configured to instruct the processors 414 to process the digital image data 430. By way of non-limiting example, the image processing instructions 428 may be configured to use optical character recognition (OCR) to recognize text. In embodiments where the sample material includes a gemstone (e.g., the gemstone 102 of FIG. 1A and FIG. 1B), a text inscription may be detected and read using OCR. Also by way of non-limiting example, the inscription may include a QR code, a bar code, or other visible code that may be recognized and captured using image processing instructions 428.

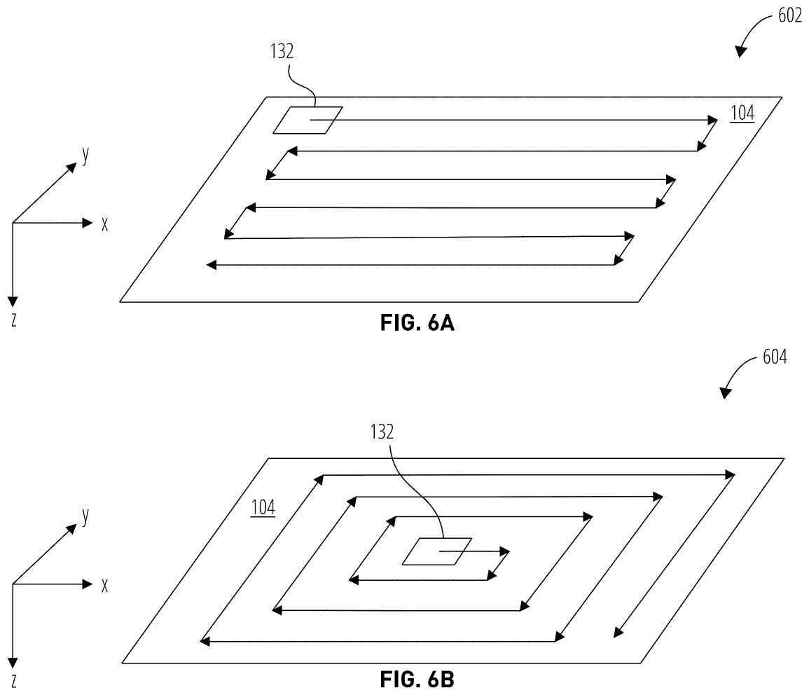

In some embodiments, the imaging system 400 may be configured to automate detection of one or more structures of a material sample. For example, the imaging system 400 may be configured to automate detection and/or read an inscription. The processors 414 may be configured to control the stage 300 (e.g., via the stage tilt signals 420 and/or the stage motion signals 422) to move the field of view 132 (FIG. 1A and FIG. 1B) across a material sample to scan the material sample for an inscription or other structure. FIG. 6A and FIG. 6B illustrate examples of scan patterns of a field of view 132 of the camera 114 across a table 104 of a gemstone 102 (FIG. 1A and FIG. 1B) as the processors 414 control the stage 300 to move (e.g., using the stage motion signals 422).

The processors 414 may also attempt to detect an inscription or other structure in the material sample using different EM radiation sources (e.g., the top light arrangement 122, the bottom light source 126, and/or the top-side light 128) individually, and/or or in different combinations of two or more of the light sources together. Different types of inscriptions may be more visible in certain lighting conditions, and the lighting control instructions 408 may be configured to instruct the processors 414 to vary the lighting conditions (e.g., using the lighting control signals 418) to make the inscription visible to the camera 114.

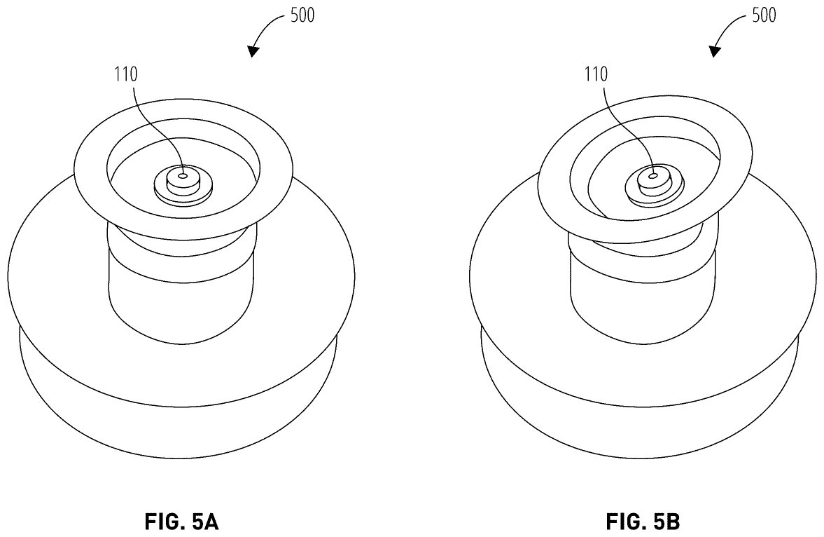

FIG. 5A and FIG. 5B are perspective views of a manually-adjustable stage 500, which is an example of the stage 112 of FIG. 1A and FIG. 1B. The manually-adjustable stage 500 may be tilted at various different angles relative to horizontal around various different axes and/or moved in various different directions responsive to human manipulation of the manually-adjustable stage 500.

FIG. 6A and FIG. 6B illustrate examples of a side-to-side scan pattern 602 and a spiral scan pattern 604, respectively, across the table 104 of the gemstone 102 of FIG. 1A. These scan patterns may be used to search for an inscription in the gemstone 102. In some examples, movement of the stage 112 may be manually operated by a human manipulating a computing system (e.g., the computing system 402 of FIG. 4). For example, a user may send commands to the individual stage motors (e.g., the stage motion signals to the x-axis movement motor 306, the y-axis movement motor 308, and/or the z-axis movement motor 310). In some examples, the computer systems described herein may be connected to or in communication with the motors, and image analysis by the computing system of digital images captured by the camera 114 (FIG. 1A, FIG. 1B, FIG. 4) may be used to search for and capture images of an inscription. In some examples, a search pattern may be used to scan over the gemstone table 104 to find inscriptions, as the field of view 132 of the camera 114 (FIG. 1A, FIG. 1B, FIG. 4) is moved around the table 104 (e.g., in a zig-zag scan pattern or a stair step scan pattern).

Scan patterns such as the side-to-side scan pattern 602 and the spiral scan pattern 604 may be implemented by automatically moving the stage by stage motors in the x and y directions (e.g., by providing the stage motion signals to the x-axis movement motor 306 and y-axis movement motor 308 as illustrated in FIG. 4). In some examples, additionally or alternatively, a camera system including the camera 114 and/or the mirror 118 of FIG. 1A and FIG. 1B may move in order to move the field of view 132 across the table 104 instead of or in addition to moving the stage 112.

Although the side-to-side scan pattern 602 and the spiral scan pattern 604 of FIG. 6A and FIG. 6B, respectively, illustrate only two dimensional scans in the x and y directions, it will be appreciated that scan patterns according to various embodiments disclosed herein may also include three-dimensional scan patterns. For example, in addition to x and y direction movements of the field of view 132, the stage may be moved in a z direction and/or a focus of the camera may be changed to move the field of view 132 into and/or back out of the gemstone to scan the field of view 132 in the z direction. Accordingly, in some embodiments, scanning a field of view 132 of the camera (e.g., the camera 114 of FIG. 1A and FIG. 1B) across and into the table 104 of the gemstone may be accomplished by controlling stage motors configured to move the stage in one or more directions (e.g., one, two, or three directions corresponding to the x, y, and z directions).

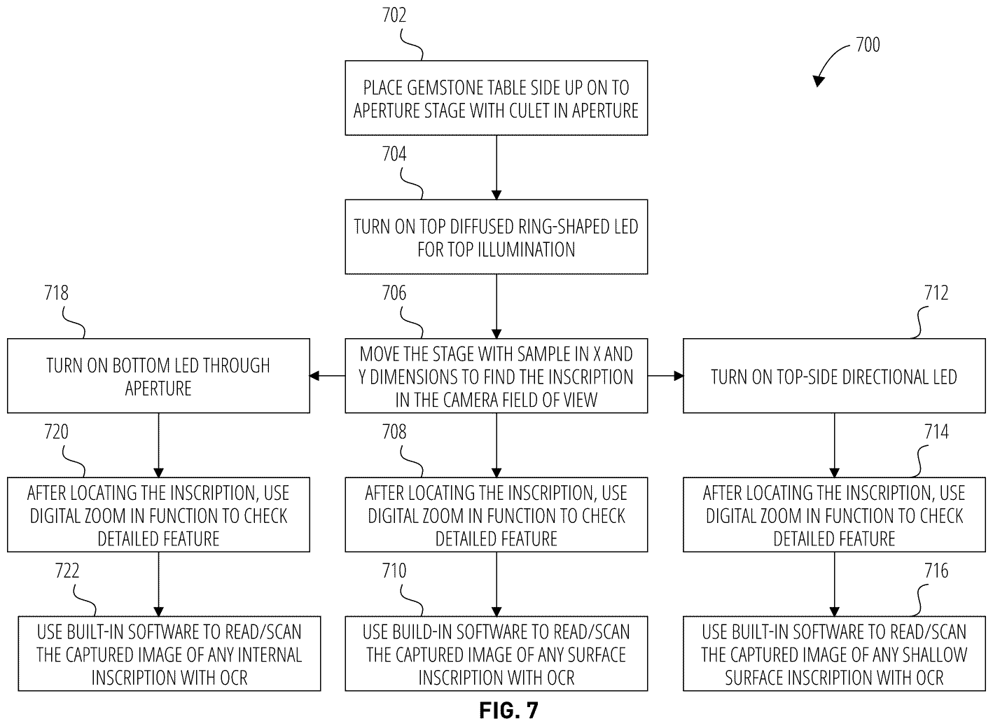

FIG. 7 is a flowchart illustrating a method 700 of finding and capturing images of inscriptions in a sample material, according to some embodiments. At operation 702, the method includes placing a gemstone table side up on to an aperture stage (e.g., the stage 112 of FIG. 1A, the stage 300 of FIG. 3A, the manually-adjustable stage 500 of FIG. 5A) with its culet in an aperture (e.g., the aperture 110 of FIG. 1A and FIG. 1B) of the stage. In some embodiments, the gemstone may be placed on the stage in a girdle-side up arrangement, as shown in FIG. 1B.

At operation 704, the method 700 includes turning on a top diffused ring-shape LED (e.g., the top light arrangement 122 of FIG. 1A and FIG. 1B) for top illumination. The method 700 may also include optional operation 706, which includes moving the stage with the sample material in X and Y dimensions to find the inscription in the camera field of view. At operation 708, the method 700 include, after locating the inscription, using a digital zoom in function to check detailed features of the inscription. At operation 708 the method 700 using built-in software (e.g., the image processing instructions 428 of FIG. 4) to read/scan the captured image of any black surface and internal inscription with OCR.

The method 700 also includes optional operations to use various imaging systems disclosed herein to view both shallow surface or invisible internal inscriptions, as well as internal inscriptions.

Additionally or alternatively, to view shallow surface inscriptions, after operation 706, the method 700 may transition to operation 712, which includes turning on a top-side directional LED (e.g., top-side light 128 of FIG. 1A and FIG. 1B). At operation 714, the method 700 includes, after locating the inscription, using the digital zoom in function to check detailed features of the inscription. At operation 716, the method 700 includes using built-in software (e.g., the image processing instructions 428 of FIG. 4) to read/scan the captured image of any shallow surface inscription with OCR.

Additionally or alternatively, to view invisible internal inscriptions, after operation 706, the method 700 may transition to operation 718, which includes turning on a bottom LED (e.g., the bottom light source 126 of FIG. 1A and FIG. 1B) through the aperture (e.g., the aperture 110 of FIG. 1A and FIG. 1B). At operation 720, the method 700 includes, after locating the inscription, using the digital zoom in function to check detailed features of the inscription. At block 722, the method 700 includes using built-in software (e.g., the image processing instructions 428 of FIG. 4) to read/scan the captured image of any internal inscription with OCR.

Such systems and methods may be used to find and identify inclusions such as surface scratches, internal inclusions, or any and all cracks, needles, graining, fractures, cavities, or other features.

Examples described here may be used in any combination or permutation. Further examples of other lighting condition and imaging magnification may also be used. For example, the bottom LED can be either diffused or non-diffused light. In another example, alone or in any combination, the top LED is only for better display of black internal inscription and surface inscription, but turning it off does not affect the application. In another example, alone or in any combination, magnification of imaging system is about 6.5× which may reveal finer features and may be further increased, however, increasing in magnification will also reduce the field of view as the tradeoff.

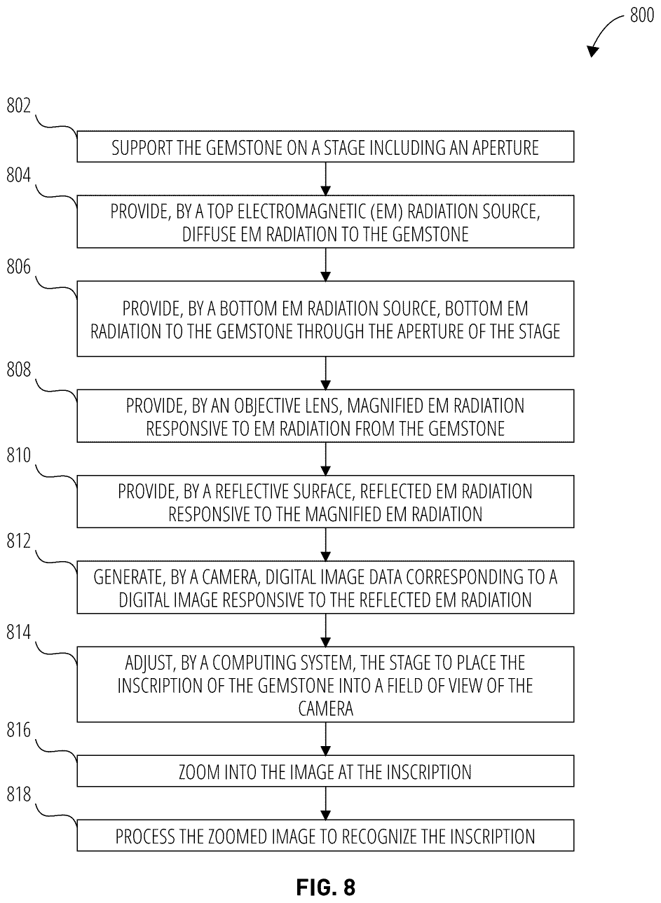

FIG. 8 is a flowchart illustrating a method 800 of detecting an inscription in a gemstone. At operation 802, method 800 includes supporting the gemstone on a stage including an aperture. At operation 804, method 800 includes providing, by a top electromagnetic (EM) radiation source, top EM radiation to the gemstone. At operation 806, method 800 includes providing, by a bottom EM radiation source, bottom EM radiation to the gemstone through the aperture of the stage. At operation 808, method 800 includes providing, by an objective lens, magnified EM radiation responsive to EM radiation from the gemstone. At operation 810, method 800 includes providing, by a reflective surface, reflected EM radiation responsive to the magnified EM radiation. At operation 812, method 800 includes generating, by a camera, digital image data corresponding to a digital image responsive to the reflected EM radiation. At operation 814, method 800 includes adjusting, by a computing system, the stage to place the inscription of the gemstone into a field of view of the camera. At operation 816, the method 800 includes zooming into the image at the inscription. At operation 818, method 800 includes processing the zoomed image to recognize the inscription.

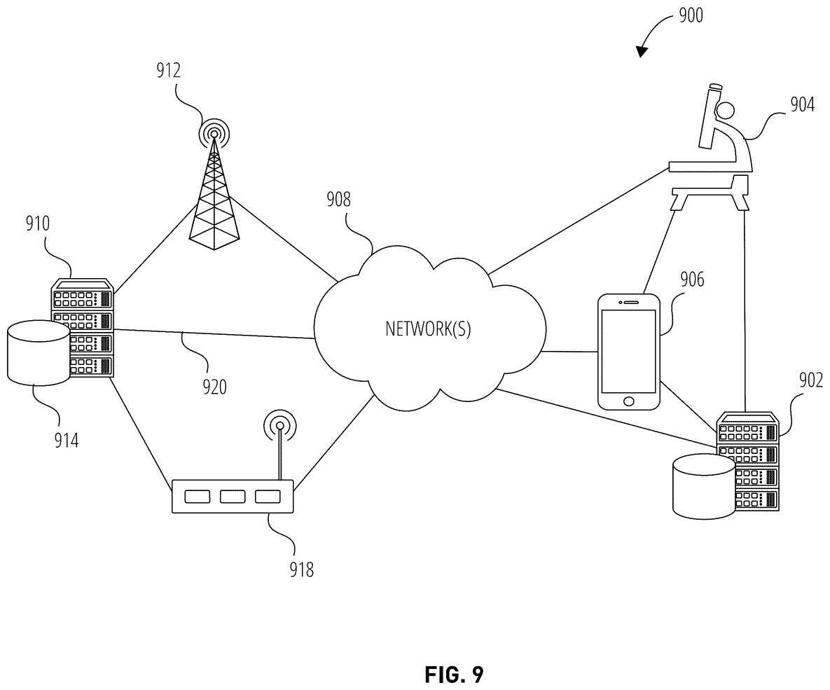

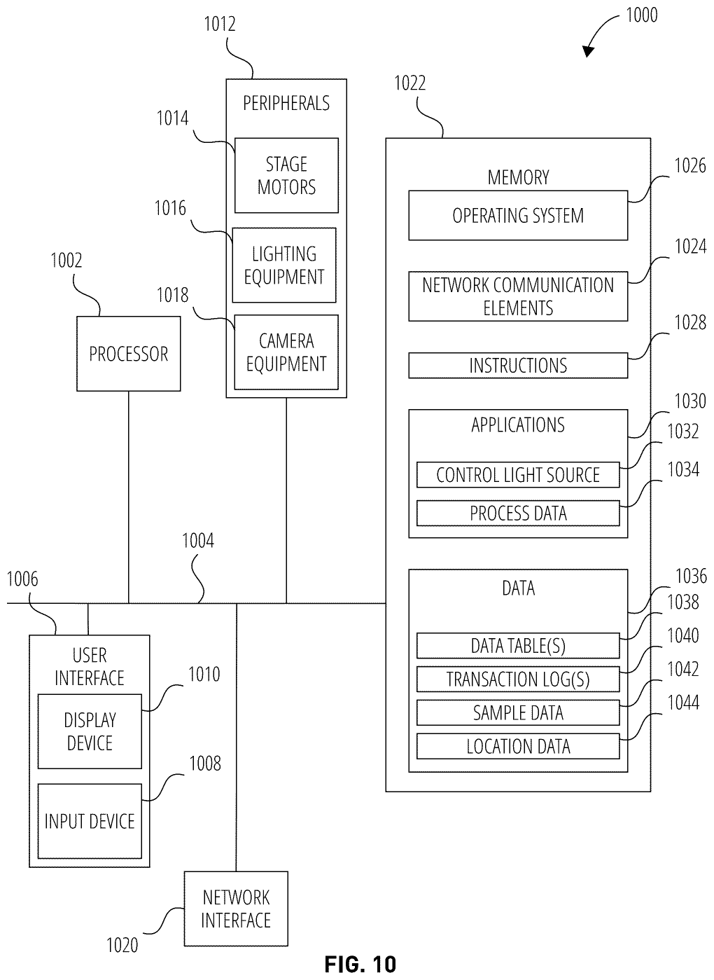

Various systems and methods disclosed herein may utilize a networked computing arrangement 900 as shown in FIG. 9. The networked computing arrangement 900 includes an imaging system 904 (e.g., the imaging system 100 of FIG. 1A and FIG. 1B, the imaging system 200 of FIG. 2, the imaging system 400 of FIG. 4) and a computer 902 (e.g., the computing system 402 of FIG. 4). The computer 902 may be used to process pixel data (e.g., digital image data 430 of FIG. 4) of captured images of the camera (e.g., the camera 114 of FIG. 1B and FIG. 1B). The computer 902 may also be used to send and receive instructions to the stage motors (e.g., the stage tilt signals 420 and the stage motion signals 422 to the x-axis tilt motor 302, the y-axis tilt motor 304, the x-axis movement motor 306, the y-axis movement motor 308, and the z-axis movement motor 310 of FIG. 4), or send and receive other data such as sample location, wireframe data of gemstones, identification information of the gemstones, time and date, etc. The computer 902 used for these operations may be any number of kinds of computers such as those included in the camera itself, and/or another computer arrangement in communication with the camera components including but not limited to a laptop, desktop, tablet, phablet, smartphone 906, or any other kind of device used to process and transmit digitized data. More examples are discussed with reference to FIG. 10.

Referring once again to FIG. 9, the data captured for the pixelated image, calibration file, stone sample identifying information, location, and/or sample tilt may be analyzed on a back end computer 910 instead of or in addition to a local computer (e.g., the computer 902). In such examples, data may be transmitted to a back end computer 910 and associated data storage 914 via one or more network(s) 908 for saving, analysis, computation, comparison, or other manipulation. In some examples, additionally or alternatively, the transmission of data may be wireless by cellular data networks 912 or via Wi-Fi transmission with associated routers and hubs 918. In some examples, additionally or alternatively, the transmission may be through a wired connection 920. In some examples, additionally or alternatively, the transmission may be through a network such as the internet to the back end computer 910 and associated data storage 914.

At the back end computer 910 and associated data storage 914, the pixelated image data, calibration file, sample identification, sample location, time, date, and/or sample tilt may be stored, analyzed, and compared to previously stored image data and/or wireframe data for matching, identification, and/or any other kind of data analysis. In some examples, additionally or alternatively, the storing, analyzing, and/or processing of data may be accomplished at the computer 902, which may be involved in the original image capture and/or data collection. In some examples, additionally or alternatively, the data storing, analyzing, and/or processing may be shared between the local computer 902 and a back end computer 910. In such examples, networked computer resources may allow for more data processing power to be utilized than may be otherwise available at the local computers 902. In such a way, the processing and/or storage of data may be offloaded to the compute resources that are available. In some examples, additionally or alternatively, the networked computer resources may be virtual machines in a cloud or distributed infrastructure. In some examples, additionally or alternatively, the networked computer resources may be spread across multiple physical or virtual computer resources by a cloud infrastructure. The example of a server implemented as a single back end computer 910 is not intended to be limiting and is only one example of a compute resource that may be utilized by the systems and methods described herein. In some examples, additionally or alternatively, artificial intelligence and/or machine learning may be used to analyze the image data from the samples, align the sample with the camera and/or focus the imaging camera for use with stage movement. Such systems may employ data sets to train algorithms to help produce better and better results of imaging of samples, alignment of samples, analysis of samples, identification of focused samples, stage movement, camera movement, and the like.

FIG. 10 is a diagram of an example computing system 1000 in accordance with certain aspects described herein. The example computing system 1000 includes a central processing unit (CPU) or processor 1002 in communication, by communication elements 1004 (e.g., a bus or other communication elements), with a user interface 1006. The user interface 1006 includes an example input device 1008 such as a keyboard, mouse, touchscreen, button, joystick, or other user input device(s). The user interface 1006 also includes a display device 1010 such as a screen. The communication elements 1004 are in communication with the processor 1002 and other components. The network interface 1020 may allow the computing system 1000 to communicate with other computers, databases, networks, user devices, or any other computing capable devices. In some examples, additionally or alternatively, the method of communication may be through WIFI, cellular, Bluetooth Low Energy, wired communication, or any other kind of communication. In some examples, additionally or alternatively, the example computing system 1000 includes peripherals 1012 also in communication with the processor 1002. In some examples, additionally or alternatively, peripherals include stage motors 1014 such as electric servo and/or stepper motors used for moving the stage for the sample analysis. In some examples peripherals 1012 may include camera equipment 1018, and/or lighting equipment 1016. In some examples, computing system 1000 includes a memory 1022 in communication with the processor 1002. In some examples, additionally or alternatively, this memory 1022 may include instructions to execute software such as an operating system 1026, network communication elements 1024, other instructions 1028, applications 1030 (applications to control light sources 1032, applications to process data 1034 such as image pixels), data 1036 (e.g., data tables 1038, transaction logs 1040, sample data 1042, sample location data 1044, or any other kind of data).

As disclosed herein, features consistent with the present embodiments may be implemented via computer-hardware, software, and/or firmware. For example, the systems and methods disclosed herein may be embodied in various forms including, for example, a data processor, such as a computer that also includes a database, digital electronic circuitry, firmware, software, computer networks, servers, or in combinations of them. Further, while some of the disclosed implementations describe specific hardware components, systems and methods consistent with the innovations herein may be implemented with any combination of hardware, software and/or firmware. Moreover, the above-noted features and other aspects and principles of the innovations herein may be implemented in various environments. Such environments and related applications may be specially constructed for performing the various routines, processes and/or operations according to the embodiments or they may include a computer or computing platform selectively activated or reconfigured by code to provide the necessary functionality. The processes disclosed herein are not inherently related to any particular computer, network, architecture, environment, or other apparatus, and may be implemented by a suitable combination of hardware, software, and/or firmware. For example, various machines may be used with programs written in accordance with teachings of the embodiments, or it may be more convenient to construct a specialized apparatus or system to perform the required methods and techniques.

Aspects of the method and system described herein, such as the logic, may be implemented as functionality programmed into any of a variety of circuitry, including programmable logic devices (“PLDs”), such as field programmable gate arrays (“FPGAs”), programmable array logic (“PAL”) devices, electrically programmable logic and memory devices and standard cell-based devices, as well as application specific integrated circuits. Some other possibilities for implementing aspects include: memory devices, microcontrollers with memory (such as EEPROM), embedded microprocessors, firmware, software, etc. Furthermore, aspects may be embodied in microprocessors having software-based circuit emulation, discrete logic (sequential and combinatorial), custom devices, fuzzy (neural) logic, quantum devices, and hybrids of any of the above device types. The underlying device technologies may be provided in a variety of component types, e.g., metal-oxide semiconductor field-effect transistor (“MOSFET”) technologies like complementary metal-oxide semiconductor (“CMOS”), bipolar technologies like emitter-coupled logic (“ECL”), polymer technologies (e.g., silicon-conjugated polymer and metal-conjugated polymer-metal structures), mixed analog and digital, and so on.

It should also be noted that the various logic and/or functions disclosed herein may be enabled using any number of combinations of hardware, firmware, and/or as data and/or instructions embodied in various machine-readable or computer-readable media, in terms of their behavioral, register transfer, logic component, and/or other characteristics. Computer-readable media in which such formatted data and/or instructions may be embodied include, but are not limited to, non-volatile storage media in various forms (e.g., optical, magnetic or semiconductor storage media) and carrier waves that may be used to transfer such formatted data and/or instructions through wireless, optical, or wired signaling media or any combination thereof. Examples of transfers of such formatted data and/or instructions by carrier waves include, but are not limited to, transfers (uploads, downloads, e-mail, etc.) over the Internet and/or other computer networks via one or more data transfer protocols (e.g., HTTP, FTP, SMTP, and so on).

Unless the context clearly requires otherwise, throughout the description and the claims, the words “comprise,” “comprising,” and the like are to be construed in an inclusive sense as opposed to an exclusive or exhaustive sense; that is to say, in a sense of “including, but not limited to.” Words using the singular or plural number also include the plural or singular number respectively. Additionally, the words “herein,” “hereunder,” “above,” “below,” and words of similar import refer to this application as a whole and not to any particular portions of this application. When the word “or” is used in reference to a list of two or more items, that word covers all of the following interpretations of the word: any of the items in the list, all of the items in the list and any combination of the items in the list.

Although certain presently preferred implementations of the descriptions have been specifically described herein, it will be apparent to those skilled in the art to which the descriptions pertains that variations and modifications of the various implementations shown and described herein may be made without departing from the spirit and scope of the embodiments. Accordingly, it is intended that the embodiments be limited only to the extent required by the applicable rules of law.

The present embodiments can be embodied in the form of methods and apparatus for practicing those methods. The present embodiments can also be embodied in the form of program code embodied in tangible media, such as floppy diskettes, CD-ROMs, hard drives, or any other machine-readable storage medium, wherein, when the program code is loaded into and executed by a machine, such as a computer, the machine becomes an apparatus for practicing the embodiments. The present embodiments can also be in the form of program code, for example, whether stored in a storage medium, loaded into and/or executed by a machine, or transmitted over some transmission medium, such as over electrical wiring or cabling, through fiber optics, or via electromagnetic radiation, wherein, when the program code is loaded into and executed by a machine, such as a computer, the machine becomes an apparatus for practicing the embodiments. When implemented on a processor, the program code segments combine with the processor to provide a unique device that operates analogously to specific logic circuits.

The software is stored in a machine readable medium that may take many forms, including but not limited to, a tangible storage medium, a carrier wave medium or physical transmission medium. Non-volatile storage media include, for example, optical or magnetic disks, such as any of the storage devices in any computer(s) or the like. Volatile storage media include dynamic memory, such as main memory of such a computer platform. Tangible transmission media include coaxial cables; copper wire and fiber optics, including the wires that comprise a bus within a computer system. Carrier-wave transmission media can take the form of electric or electromagnetic signals, or acoustic or light waves such as those generated during radio frequency (RF) and infrared (IR) data communications. Common forms of computer-readable media therefore include for example: disks (e.g., hard, floppy, flexible) or any other magnetic medium, a CD-ROM, DVD or DVD-ROM, any other optical medium, any other physical storage medium, a RAM, a PROM and EPROM, a FLASH-EPROM, any other memory chip, a carrier wave transporting data or instructions, cables or links transporting such a carrier wave, or any other medium from which a computer can read programming code and/or data. Many of these forms of computer readable media may be involved in carrying one or more sequences of one or more instructions to a processor for execution.

The foregoing description, for purpose of explanation, has been described with reference to specific embodiments. However, the illustrative discussions above are not intended to be exhaustive or to limit the embodiments to the precise forms disclosed. Many modifications and variations are possible in view of the above teachings. The embodiments were chosen and described in order to best explain the principles of the embodiments and its practical applications, to thereby enable others skilled in the art to best utilize the various embodiments with various modifications as are suited to the particular use contemplated.

What is claimed is:

1. An imaging system, comprising:
a stage for supporting a material sample, the stage comprising an aperture;
a top electromagnetic (EM) radiation source that directs diffuse EM radiation downwardly toward to the material sample supported by the stage;
a bottom EM radiation source that directs bottom EM radiation toward the material sample through the aperture;
an objective lens positioned above the stage which collects EM radiation from the material sample and forms a magnified image of at least a portion of the material sample;
an image capture device that generates digital image data of the magnified image; and
a reflective surface positioned to receive EM radiation via the objective lens and to reflect the EM radiation laterally to form the magnified image.

2. The system of claim 1, wherein the aperture is defined by an adjustable iris.

3. The system of claim 1, wherein the top EM radiation source includes an annular EM radiation source comprising an annularly-shaped light emitting diode (LED) or an annular arrangement of multiple LEDs.

4. The system of claim 3, wherein the objective lens is at least partially encircled by the annular EM radiation source.

5. The system of claim 1, wherein the top EM radiation source comprises one or more light emitting diodes (LEDs) capable of emitting light across a first spectrum and the bottom EM radiation source includes one or more LEDs capable of emitting light across a second spectrum that is different from the first spectrum.

6. The system of claim 1, wherein the material sample comprises a gemstone and the aperture is sized to receive a portion of the gemstone for supporting the gemstone in a selected position.

7. The system of claim 1, wherein the stage includes one or more stage motors configured to move the stage in one or more directions.

8. The system of claim 1, wherein the stage includes one or more tilt stage motors configured to tilt the stage about one or more axes.

9. The system of claim 1, further comprising a directional top-side EM source adjacent to the top EM source, the top-side EM source configured to illuminate the material sample from a side angle.

10. A method of detecting an inscription in a gemstone, the method comprising:
supporting the gemstone on a stage including an aperture;
providing, by a top electromagnetic (EM) radiation source, diffuse EM radiation to the gemstone;
providing, by a bottom EM radiation source, bottom EM radiation to the gemstone through the aperture of the stage;
providing, by an objective lens, magnified EM radiation responsive to EM radiation from the gemstone;
providing, by a reflective surface, reflected EM radiation responsive to the magnified EM radiation;
generating, by a camera, digital image data corresponding to a digital image responsive to the reflected EM radiation;
adjusting, by a computing system, the stage to place the inscription of the gemstone into a field of view of the camera;
zooming into the image at the inscription; and
processing the zoomed image to recognize the inscription.

11. The method of claim 10, further comprising illuminating, by a top-side light offset horizontally from the top EM radiation source, the gemstone to directionally illuminate the gemstone on the stage in addition to the top EM radiation, wherein generating the digital image data corresponding to the digital image comprises generating the digital image data corresponding to an image of the gemstone to identify surface inscriptions of the gemstone.

12. The method of claim 11, wherein the surface inscriptions are less than one hundred microns (100 μm) deep.

13. The method of claim 10, further comprising identifying invisible internal inscriptions of the gemstone.

14. The method of claim 10, wherein the stage includes an adjustable iris, the method further comprising adjusting the aperture by the adjustable iris to match a size of a culet of the gemstone.

15. The method of claim 14, wherein the adjustable iris shutter is configured to adjust a diameter of the aperture between 0.5 mm and 2 mm.

16. The method of claim 10, wherein the top EM radiation source is ring shaped with an objective lens in the middle, the objective lens configured to focus light from the stage to the camera.

17. The method of claim 16, wherein the objective lens is configured for 5× magnification.

18. The method of claim 16, wherein the objective lens is configured for 10× magnification.

19. The method of claim 10, wherein the camera includes an imaging lens.

20. The method of claim 10, further comprising scanning a field of view of the camera across and into a table of the gemstone by controlling stage motors configured to move the stage in one or more directions.
